(19) United States
(12) Patent Application Publication
(10) Pub. No.: US 2026/0004048 A1
(43) Pub. Date: Jan. 1, 2026

(54) SYSTEMS AND METHODS RELATED TO VERIFYING ANONYMIZATION OF TEXT DATA IN CONTACT CENTERS

(71) Applicant: GENESYS CLOUD SERVICES, INC., MENLO PARK, CA (US)

(72) Inventors: MARIYA ORSHANSKY, MENLO PARK, CA (US); EMMA S. EHRHARDT, INDIANAPOLIS, IN (US); CANICE LAMBE, GALWAY (IE); JANA HOKSZOVÁ, GALWAY (IE)

(73) Assignee: GENESYS CLOUD SERVICES, INC., MENLO PARK, CA (US)

(21) Appl. No.: 18/758,372

(22) Filed: Jun. 28, 2024

(51) Int. Cl. G06F 40/109; G06F 21/62; G06F 40/279

(52) U.S. Cl. CPC G06F 40/109; G06F 21/6245; G06F 40/279

(57) ABSTRACT

A method for verifying anonymization by a first user that the subject text does not contain personal identifiable information (PII). The method includes: receiving the subject text; receiving a non-PII wordlist listing non-PII words; comparing each word appearing in the subject text to the non-PII words to determine matches therebetween so that, via the comparison, the words of the subject text are classified as being either first text, which includes the words in the subject text found to match one of the non-PII words, and second text, which includes the words in the subject text found not to match any of the non-PII words; and generating a first user interface that displays the subject text such that a visual format of the first text differs from a visual format of the second text in accordance with a visual format alteration.

### BACKGROUND

The present invention generally relates to telecommunications systems in the field of customer relations management including customer assistance via internet-based and phone-based service options. More particularly, but not by way of limitation, the present invention pertains to systems and methods for systems and methods for facilitating verification of anonymization of text data in contact centers.

### BRIEF DESCRIPTION OF THE INVENTION

The present invention describes a method for facilitating anonymization certification of a subject text by a first user, wherein the anonymization certification comprises verifying by the first user that the subject text does not contain personal identifiable information (PII). The method may include the steps of: receiving the subject text; receiving a non-PII wordlist in which are listed non-PII words; comparing each word appearing in the subject text to the non-PII words found in the non-PII wordlist to determine matches therebetween so that, via the comparison, the words of the subject text are classified as being either first text, which includes the words in the subject text found to match one of the non-PII words, and second text, which includes the words in the subject text found not to match any of the non-PII words; and generating, for use by the first user, a first user interface that displays the subject text such that a visual format of the first text differs from a visual format of the second text in accordance with a visual format alteration.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 depicts a process flow diagram showing a method of the present invention in accordance with an exemplary embodiment;

FIG. 4 depicts an exemplary user interface for implementing a process of the present invention;

FIG. 5 depicts another exemplary user interface for implementing a process of the present invention; and

FIG. 6 depicts another exemplary user interface for implementing a process of the present invention.

### DETAILED DESCRIPTION

For the purposes of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art.

As used herein, language designating nonlimiting examples and illustrations includes “e.g.”, “i.e.”, “for example”, “for instance” and the like. Further, reference throughout this specification to “an embodiment”, “one embodiment”, “present embodiments”, “exemplary embodiments”, “certain embodiments” and the like means that a particular feature, structure or characteristic described in connection with the given example may be included in at least one embodiment of the present invention. Thus, appearances of the phrases “an embodiment”, “one embodiment”, “present embodiments”, “exemplary embodiments”, “certain embodiments” and the like are not necessarily referring to the same embodiment or example. Further, particular features, structures or characteristics may be combined in any suitable combinations and/or sub-combinations in one or more embodiments or examples.

Those skilled in the art will recognize from the present disclosure that the various embodiments may be computer implemented using many different types of data processing equipment, with embodiments being implemented as an apparatus, method, or computer program product. Example embodiments, thus, may take the form of an entirely hardware embodiment, an entirely software embodiment, or an embodiment combining software and hardware aspects. Example embodiments further may take the form of a computer program product embodied by computer-usable program code in any tangible medium of expression. In each case, the example embodiment may be generally referred to as a “module”, “system”, or “method”.

### Computing Device

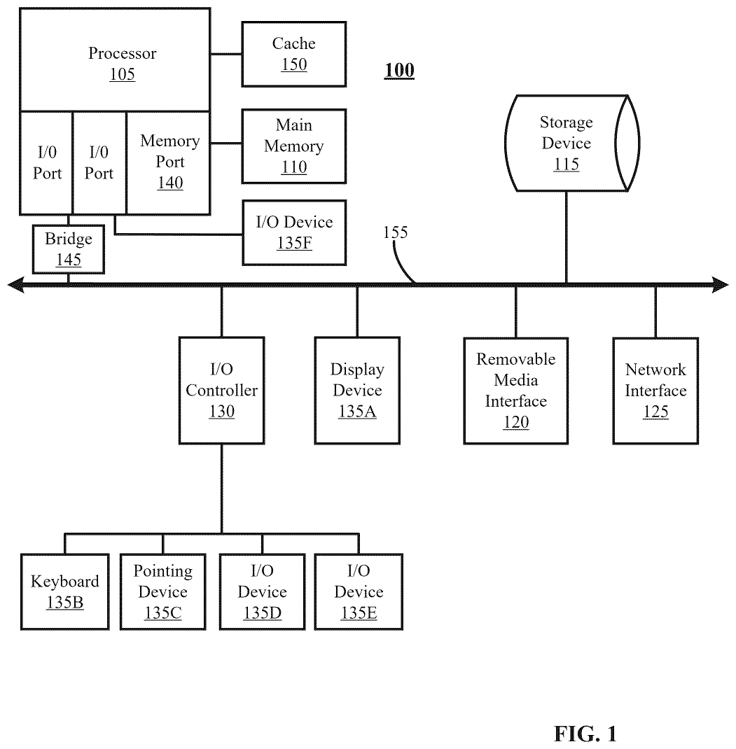

It will be appreciated that the systems and methods of the present invention may be computer implemented using many different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced. It should be understood that FIG. 1 is provided as a non-limiting example.

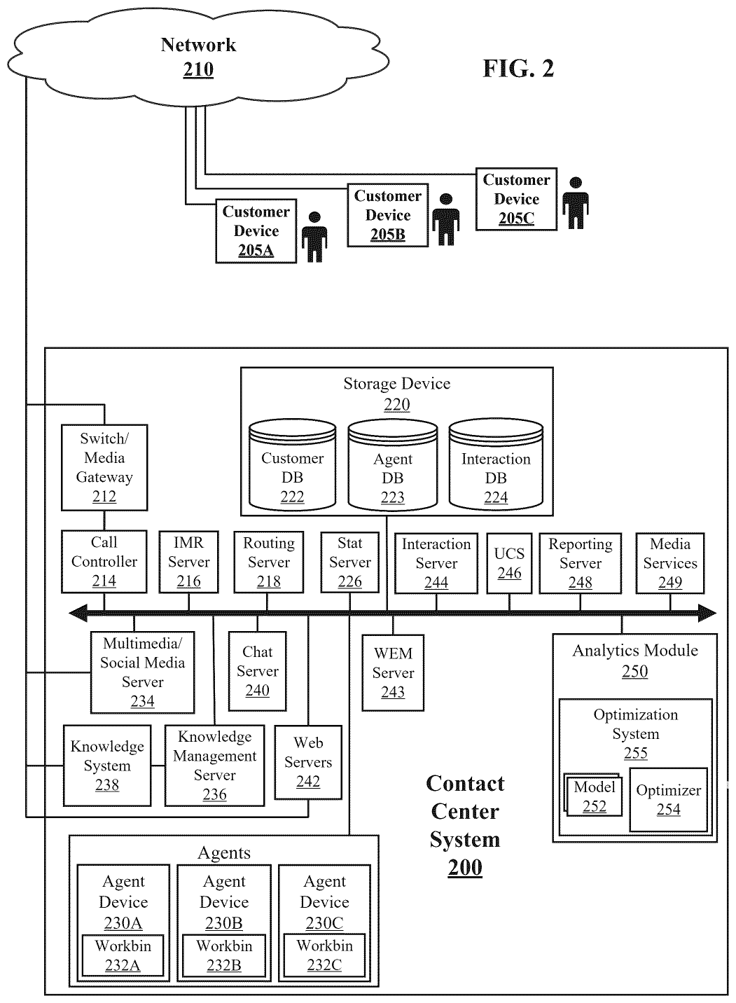

The computing device 100, for example, may be implemented via firmware (e.g., an application-specific integrated circuit), hardware, or a combination of software, firmware, and hardware. It will be appreciated that each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures—such as, for example, the contact center system 200 of FIG. 2—the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the process 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The cache memory 150 typically has a faster response time than main memory 110. The main memory 110 may be one or more memory chips capable of storing data and allowing stored data to be directly accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. The I/O devices 135 and/or the I/O controller 130 may include suitable hardware and/or software for enabling the use of multiple display devices. The computing device 100 may also support one or more removable media interfaces 120, such as a disk drive, USB port, or any other device suitable for reading data from or writing data to computer readable media. More generally, the I/O devices 135 may include any conventional devices for performing the functionality described herein.

The computing device 100 may be any workstation, desktop computer, laptop or notebook computer, server machine, virtualized machine, mobile or smart phone, portable telecommunication device, media playing device, gaming system, mobile computing device, or any other type of computing, telecommunications or media device, without limitation, capable of performing the operations and functionality described herein. The computing device 100 include a plurality of devices connected by a network or connected to other systems and resources via a network. As used herein, a network includes one or more computing devices, machines, clients, client nodes, client machines, client computers, client devices, endpoints, or endpoint nodes in communication with one or more other computing devices, machines, clients, client nodes, client machines, client computers, client devices, endpoints, or endpoint nodes. It should be understood that, unless otherwise limited, the computing device 100 may communicate with other computing devices 100 via any type of network using any conventional communication protocol. Further, the network may be a virtual network environment where various network components are virtualized.

### Contact Center

With reference now to FIG. 2, a communications infrastructure or contact center system 200 is shown in accordance with exemplary embodiments of the present invention and/or with which exemplary embodiments of the present invention may be enabled or practiced. It should be understood that the term “contact center system” is used herein to refer to the system depicted in FIG. 2 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 200), the associated customer service provider (such as a particular customer service provider providing customer services through the contact center system 200), as well as the organization or enterprise on behalf of which those customer services are being provided.

By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and the like.

Referring specifically to FIG. 2, the contact center system 200 may be used by a customer service provider to provide various types of services to customers. For example, the contact center system 200 may be used to engage and manage interactions in which automated processes (or bots) or human agents communicate with customers. As should be understood, the contact center system 200 may be an in-house facility to a business or enterprise for performing the functions of sales and customer service relative to products and services available through the enterprise. In another aspect, the contact center system 200 may be operated by a third-party service provider that contracts to provide services for another organization. Further, the contact center system 200 may be deployed on equipment dedicated to the enterprise or third-party service provider, and/or deployed in a remote computing environment such as, for example, a private or public cloud environment with infrastructure for supporting multiple contact centers for multiple enterprises. The contact center system 200 may include software applications or programs, which may be executed on premises or remotely or some combination thereof. It should further be appreciated that the various components of the contact center system 200 may be distributed across various geographic locations and not necessarily contained in a single location or computing environment.

It should further be understood that, unless otherwise specifically limited, any of the computing elements of the present invention may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center system 200 may include: a plurality of customer devices 205A, 205B, 205C; communications network (or simply “network”) 210; switch/media gateway 212; call controller 214; interactive media response (IMR) server 216; routing server 218; storage device 220; statistics (or “stat”) server 226; plurality of agent devices 230A, 230B, 230C that include workbins 232A, 232B, 232C, respectively; multimedia/social media server 234; knowledge management server 236 coupled to a knowledge system 238; chat server 240; web servers 242; interaction (or “iXn”) server 244; universal contact server (or “UCS”) 246; reporting server 248; media services server 249; and analytics module 250. It should be understood that any of the computer-implemented components, modules, or servers described in relation to FIG. 2 or in any of the following figures may be implemented via types of computing devices, such as, for example, the computing device 100 of FIG. 1. As will be seen, the contact center system 200 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and the like.

Customers desiring to receive services from the contact center system 200 may initiate inbound communications (e.g., telephone calls, emails, chats, etc.) to the contact center system 200 via a customer device 205. While FIG. 2 shows three such customer devices—i.e., customer devices 205A, 205B, and 205C—it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center system 200, such as telephone calls, emails, chats, text messages, web-browsing sessions, and other multi-media transactions.

Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access (CDMA) network, global system for mobile communications (GSM) network, or any wireless network/technology conventional in the art, including but not limited to 3G, 4G, LTE, 5G, etc.

In regard to the switch/media gateway 212, it may be coupled to the network 210 for receiving and transmitting telephone calls between customers and the contact center system 200. The switch/media gateway 212 may include a telephone or communication switch configured to function as a central switch for agent level routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. Thus, in general, the switch/media gateway 212 establishes a voice connection between the customer and the agent by establishing a connection between the customer device 205 and agent device 230.

As further shown, the switch/media gateway 212 may be coupled to the call controller 214 which, for example, serves as an adapter or interface between the switch and the other routing, monitoring, and communication-handling components of the contact center system 200. The call controller 214 may be configured to process PSTN calls, VoIP calls, etc. For example, the call controller 214 may include computer-telephone integration (CTI) software for interfacing with the switch/media gateway and other components. The call controller 214 may include a session initiation protocol (SIP) server for processing SIP calls. The call controller 214 may also extract data about an incoming interaction, such as the customer's telephone number, IP address, or email address, and then communicate these with other contact center components in processing the interaction.

In regard to the interactive media response (IMR) server 216, it may be configured to enable self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. For example, a contact center for a bank may tell customers via the IMR script to “press 1” if they wish to retrieve their account balance. Through continued interaction with the IMR server 216, customers may receive service without needing to speak with an agent. The IMR server 216 may also be configured to ascertain why a customer is contacting the contact center so that the communication may be routed to the appropriate resource.

In regard to the routing server 218, it may function to route incoming interactions. For example, once it is determined that an inbound communication should be handled by a human agent, functionality within the routing server 218 may select the most appropriate agent and route the communication thereto. This agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230. This information is intended to enhance the service the agent is able to provide to the customer.

Regarding data storage, the contact center system 200 may include one or more mass storage devices-represented generally by the storage device 220—for storing data in one or more databases relevant to the functioning of the contact center. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center system 200 may include agent availability and agent profiles, schedules, skills, handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center system 200 in ways that facilitate the functionality described herein. For example, the servers or modules of the contact center system 200 may query such databases to retrieve data stored therewithin or transmit data thereto for storage.

In regard to the stat server 226, it may be configured to record and aggregate data relating to the performance and operational aspects of the contact center system 200. Such information may be compiled by the stat server 226 and made available to other servers and modules, such as the reporting server 248, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center system 200 in ways that facilitate functionality described herein. An agent device 230, for example, may include a telephone adapted for regular telephone calls or VoIP calls. An agent device 230 may further include a computing device configured to communicate with the servers of the contact center system 200, perform data processing associated with operations, and interface with customers via voice, chat, email, and other multimedia communication mechanisms according to functionality described herein. While FIG. 2 shows three such agent devices—i.e., agent devices 230A, 230B and 230C—it should be understood that any number may be present.

In regard to the multimedia/social media server 234, it may be configured to facilitate media interactions (other than voice) with the customer devices 205 and/or the servers 242. Such media interactions may be related, for example, to email, voice mail, chat, video, text-messaging, web, social media, co-browsing, etc. The multi-media/social media server 234 may take the form of any IP router conventional in the art with specialized hardware and software for receiving, processing, and forwarding multi-media events and communications.

In regard to the knowledge management server 234, it may be configured to facilitate interactions between customers and the knowledge system 238. In general, the knowledge system 238 may be a computer system capable of receiving questions or queries and providing answers in response. The knowledge system 238 may be included as part of the contact center system 200 or operated remotely by a third party. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials, as is known in the art. As an example, the knowledge system 238 may be embodied as IBM Watson or a like system.

In regard to the chat server 240, it may be configured to conduct, orchestrate, and manage electronic chat communications with customers. In general, the chat server 240 is configured to implement and maintain chat conversations and generate chat transcripts. Such chat communications may be conducted by the chat server 240 in such a way that a customer communicates with automated chatbots, human agents, or both. In exemplary embodiments, the chat server 240 may perform as a chat orchestration server that dispatches chat conversations among the chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature, including those UIs generated at either the customer device 205 or the agent device 230. The chat server 240 may be configured to transfer chats within a single chat session with a particular customer between automated and human sources such that, for example, a chat session transfers from a chatbot to a human agent or from a human agent to a chatbot. The chat server 240 may also be coupled to the knowledge management server 234 and the knowledge systems 238 for receiving suggestions and answers to queries posed by customers during a chat so that, for example, links to relevant articles can be provided.

In regard to the web servers 242, such servers may be included to provide site hosts for a variety of social interaction sites to which customers subscribe, such as Facebook, Twitter, Instagram, etc. Though depicted as part of the contact center system 200, it should be understood that the web servers 242 may be provided by third parties and/or maintained remotely. The web servers 242 may also provide webpages for the enterprise or organization being supported by the contact center system 200. For example, customers may browse the webpages and receive information about the products and services of a particular enterprise. Within such enterprise webpages, mechanisms may be provided for initiating an interaction with the contact center system 200, for example, via web chat, voice, or email. An example of such a mechanism is a widget, which can be deployed on the webpages or websites hosted on the web servers 242. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

In regard to the interaction (iXn) server 244, it may be configured to manage deferrable activities of the contact center and the routing thereof to human agents for completion. As used herein, deferrable activities include back-office work that can be performed off-line, e.g., responding to emails, attending training, and other activities that do not entail real-time communication with a customer.

In regard to the universal contact server (UCS) 246, it may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer such as, for example, data related to comments from agents, customer communication history, and the like. Each of these data types then may be stored in the customer database 222 or on other modules and retrieved as functionality described herein requires.

In regard to the reporting server 248, it may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to specific requests from a requestor (e.g., agent, administrator, contact center application, etc.). The reports then may be used toward managing the contact center operations in accordance with functionality described herein.

In regard to the media services server 249, it may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and the like.

In regard to the analytics module 250, it may be configured to provide systems and methods for performing analytics on data received from a plurality of different data sources as functionality described herein may require. In accordance with example embodiments, the analytics module 250 also may generate, update, train, and modify predictors or models 252 based on collected data, such as, for example, customer data, agent data, and interaction data. The models 252 may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module 250 is depicted as being part of a contact center, such behavior models also may be implemented on customer systems (or, as also used herein, on the “customer-side” of the interaction) and used for the benefit of customers.

According to exemplary embodiments, the analytics module 250 may have access to the data stored in the storage device 220, including the customer database 222 and agent database 223. The analytics module 250 also may have access to the interaction database 224, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, as discussed more below, the analytic module 250 may be configured to retrieve data stored within the storage device 220 for use in developing and training algorithms and models 252, for example, by applying machine learning techniques.

One or more of the included models 252 may be configured to predict customer or agent behavior and/or aspects related to contact center operation and performance. Further, one or more of the models 252 may be used in natural language processing and, for example, include intent recognition and the like. The models 252 may be developed based upon 1) known first principle equations describing a system, 2) data, resulting in an empirical model, or 3) a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, it may be preferable that the models 252 are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach is presently a preferred embodiment for implementing the models 252. Neural networks, for example, may be developed based upon empirical data using advanced regression algorithms.

The analytics module 250 may further include an optimizer 254. As will be appreciated, an optimizer may be used to minimize a “cost function” subject to a set of constraints, where the cost function is a mathematical representation of desired objectives or system operation. Because the models 252 may be non-linear, the optimizer 254 may be a nonlinear programming optimizer. It is contemplated, however, that the present invention may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to exemplary embodiments, the models 252 and the optimizer 254 may together be used within an optimization system 255. For example, the analytics module 250 may utilize the optimization system 255 as part of an optimization process by which aspects of contact center performance and operation are optimized or, at least, enhanced. This, for example, may include aspects related to the customer experience, agent experience, interaction routing, natural language processing, intent recognition, or other functionality related to automated processes.

The various components, modules, and/or servers of FIG. 2 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VOIP calls), emails, vmails, video, chat, screen-sharing, text messages, social media messages, WebRTC calls, etc. Access to and control of the components of the contact system 200 may be affected through user interfaces (UIs) which may be generated on the customer devices 205 and/or the agent devices 230. As already noted, the contact center system 200 may operate as a hybrid system in which some or all components are hosted remotely, such as in a cloud-based or cloud computing environment.

### Anonymization of Text Data in Contact Centers

For contact centers, the dialogue occurring in the interactions between agents and customers provides a rich source of data, which is used in a variety of applications and analytics. Such conversation data may be captured as text from chats or transcribed via automatic speech recognition from voice exchanges. In either case, the text must be anonymized before it can be used. More specifically, an anonymization review has to be performed so it can be verified that all personal identifiable information (PII) is removed. As used herein, PII is defined as any representation of information that permits the identity of an individual to whom the information applies to be reasonably inferred by either direct or indirect means. As will be appreciated, the process of removing PII and verifying anonymization of text constitutes a time-consuming manual process. Nevertheless, the anonymization process is required to comply with existing privacy laws and regulations. Thus, while conventional methods may employ automated processes, such as named entity recognition (NER), to identify and enable the masking PII in text, the text must still be reviewed by a human to verify that the NER process did not make an error or miss PII in the text.

This last manual step—i.e., the requirement that 100% of the text be reviewed by a human for PII-presents a troublesome bottleneck. The person completing the review must be anonymization-trained and the review process can be lengthy, with many hours of review time being spent to build datasets. With this type of data being in such demand to train machine learning tools, this constraint is one that slows progress. Further, the manual nature of the review makes anonymization a costly process. With data privacy laws drawing ever more attention, this problematic situation is not apt to change anytime soon. Accordingly, there is an ongoing need for improved ways to perform the necessary manual review so that greater quantities of data can more efficiently be made available.

Accordingly, the present invention proposes an automated tool-which may be referred to herein as a “text formatting tool”—that processes the subject text so that the cognitive load on the reviewers is reduced and the speed of the review is increased. As will be seen, in accordance with exemplary embodiments, a list of frequently used non-PII words is generated. Non-PII words are words that have been reviewed by a user as being words substantially unlikely to constitute PII in a given subject text. In other embodiments, non-PII words may be words that have been certified as not constituting PII in a given subject text. The text formatting tool then renders the subject text (i.e., the text that is being reviewed for PII) such that non-PII occurring therewithin are visually deemphasized in relation to other words in the subject text. For example, in accordance with a preferred embodiment, non-PII words—i.e., words that are predetermined as likely not constituting PII—are “greyed out” in the subject text while all other words are more prominently rendered in a darker color, such as black. In this way, the words that have been predetermined as likely not being PII (i.e., the greyed out words) can be efficiently scanned by the human reviewer. In other embodiments, the greyed out words can be deemed as being certified as not being PII words, thus making the scanning by the human review even more efficient. In such cases, the greyed out words remain visible to provide context for reviewing the words that have not been greyed out, as such context is necessary in some instances. In either case, the reviewer is allowed to concentrate more on the words that are not visually deemphasized, as these words are where any remaining PII is much more likely to occur. When this process is employed, the complete text still remains visible to the reviewer so that the text can be verified as being 100% anonymized once the review is complete. Yet, the visual formatting changes allow the reviewer to allocate their attention in a more efficient manner.

In accordance with exemplary embodiments, an initial step is identifying words for use in compiling the non-PII wordlist. In exemplary embodiments, candidate words are identified by usage frequency. For example, a predetermined number of words having the highest usage frequency may be selected for possible inclusion in the non-PII wordlist. Such high frequency words may be selected from two different text sources. As will be seen, the different text sources may be used alone or in combination to generate the non-PII wordlist.

The first text source is a domain specific text source. As used herein, a domain specific text source refers to word usage within a particular domain. For example, a domain may be defined by a particular text corpus that is put together to include text derived from a particular source. For example, in accordance with certain embodiments, a domain specific text corpus may be text derived from past conversations occurring between agents and customers within a contact center. Such past conversations may be selected from interactions having a common subject matter characteristic. This is done to ensure that the text corpus includes language and words that are common to particular types of interactions, products, customer intents, or industries. The collection of agent-customer interactions from which the text corpus is gathered may be defined in different ways to achieve specific objectives. In exemplary embodiments, the domain specific text corpus may include at least 300 conversations between customer and agent (where each conversation has at least 30 lines. Thus, the present method may include creating a domain specific text corpus from text derived from past conversations occurring between other customers and other agents of the contact center. A use frequency is then calculated for the words appearing in the domain specific text corpus. Finally, the domain specific wordlist is generated by selecting for inclusion therein a predetermined number of the most frequently used words in the domain specific text corpus. That is, given the usage frequency of words in domain specific text corpus, a predetermined number of the most frequently used words are selected for possible inclusion in the non-PII wordlist. For example, in certain embodiments, the top three-thousand (3000) most frequently used words are selected. The wordlist generated at this stage may be referred to as a domain specific wordlist. In certain embodiments, the domain specific wordlist may form the basis for a “candidate non-PII wordlist”, which is the wordlist that becomes the non-PII wordlist once it has been reviewed and finalized by PII-trained personnel.

The second text source is a general text source. As used herein, a general text source refers to text derived from multiple general sources of text so that general word usage for a given language is represented. In this case, a general text corpus may be derived from multiple, non-related text sources, such as, for example, news sources, articles, Wikipedia, social media postings, and other available media. In this case, the present method includes creating a general text corpus from text derived from those general text sources. Then a use frequency is calculated for the words appearing in the general text corpus. Finally, a general wordlist is generated by selecting for inclusion therein a predetermined number of the most frequently used words in the general text corpus. That is, given the usage frequency of words in general text corpus, a predetermined number of the most frequently used words are selected for possible inclusion in the non-PII wordlist. For example, in certain embodiments, the top one-thousand (1000) most frequently used words are selected. The wordlist generated at this stage may be referred to as a general wordlist. In certain embodiments, the general wordlist may form the basis for the candidate non-PII wordlist, which, as stated, may then become the non-PII wordlist once it has been reviewed and finalized by a reviewer.

In other embodiments, the candidate non-PII wordlist is based on both the domain specific wordlist and general wordlist. In this case, the high frequency wordlists derived from the two word source categories are combined. The combined list may include deduplicating words that appear in both list. The resulting combination then becomes the candidate non-PII wordlist. Thus, it should be understood that the candidate non-PII wordlist may be based on the domain specific wordlist, the general wordlist, or a combination of the two.

The candidate non-PII wordlist is then reviewed and finalized. Once this occurs, the candidate non-PII wordlist becomes the non-PII wordlist. The review is done by a human reviewer, who reviews and vets the candidate non-PII wordlist. The human reviewer should have PII training and be a native speaker. During this review, the native speaker is identifying words that may constitute PII in a subject text. Such words, for example, are those that are regularly used in a variety of contexts where some involve PII. For example, the word “may” is a frequently used word that includes both non-PII contexts and PII contexts. Specifically, in regard to the PII context, the word “may” could be used as a name of a person or as the month of a person's birth date. The word “may” is also used regularly in contexts that typically do not involve PII. The reviewer identifies words of this type for removal from the candidate non-PII wordlist. Once the review is complete, the resulting list of words—i.e., the words that remain after being reviewed and trimmed by a PII-trained native speaker-then becomes the non-PII wordlist.

The non-PII wordlist is then used by the text formatting tool to enhance the PII review process. In accordance with exemplary embodiments, the text formatting tool does this by visually altering words appearing within the subject text that match words in the non-PII wordlist. The visual alteration, for example, may include enhancing a visual prominence of the words within the subject text that do not match non-PII words in relation to the visual prominence of the words of the subject text that do match non-PII words. In a preferred embodiment, words in the subject text that match words in the non-PII wordlist are “greyed out” so that such words are visually deemphasized in relation to the other non-matching words that have not been so altered. While the reviewers using this feature will still be able to read all of the words of the subject text, the darker (non-greyed out) text will stand out so that it can receive more of the reviewer's attention. In contrast, the greyed out or otherwise visually altered text can receive less attention from the reviewer, thereby enabling overall faster and more efficient review. It will be appreciated that this difference in attention paid to the visually deemphasized portion of the subject text and the visually emphasized portion is consistent with the likelihood that such portions include PII. That is, given the manner in which the non-PII wordlist is made-most commonly used words that are then confirmed by a native speaker as being non-PII words-any PII remaining in the subject text is much more likely to appear in the portion that is visually emphasized.

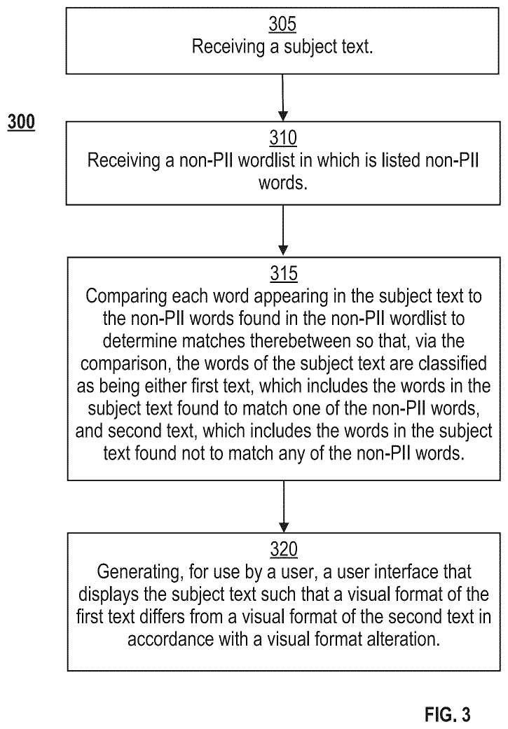

With reference now to FIG. 3, an exemplary method 300 is shown for facilitating anonymization certification of a subject text by a user (i.e., human reviewer). As used herein, anonymization certification is defined as verifying by the user that the subject text does not contain personal identifiable information (PII). PII is defined as information that permits an identity of an individual to whom the information applies to be reasonably inferred.

The method 300 may begin at step 305 by receiving the subject text. The subject text may be text derived from a conversation between an agent in a contact center and a customer. The conversation may be a chat exchange. The conversation may be a spoken exchange. When the conversation is a spoken exchange, the method may further include the steps of recording the conversation and transcribing the recorded conversation via automatic speech recognition to create the subject text.

The method 300 may continue at step 310 by receiving a non-PII wordlist in which are listed non-PII words. In alternative embodiments, the method may further include steps for generating the non-PII wordlist using a text corpus and calculated use frequency for the words included therewithin. Exemplary steps for doing this will be provided below.

The method 300 may continue at step 315 by comparing each word appearing in the subject text to the non-PII words found in the non-PII wordlist to determine matches therebetween. This is done so that, via the results of the comparison, the words of the subject text may then be classified as being either “first text”, which includes the words in the subject text found to match one of the non-PII words, or “second text”, which includes the words in the subject text found not to match any of the non-PII words.

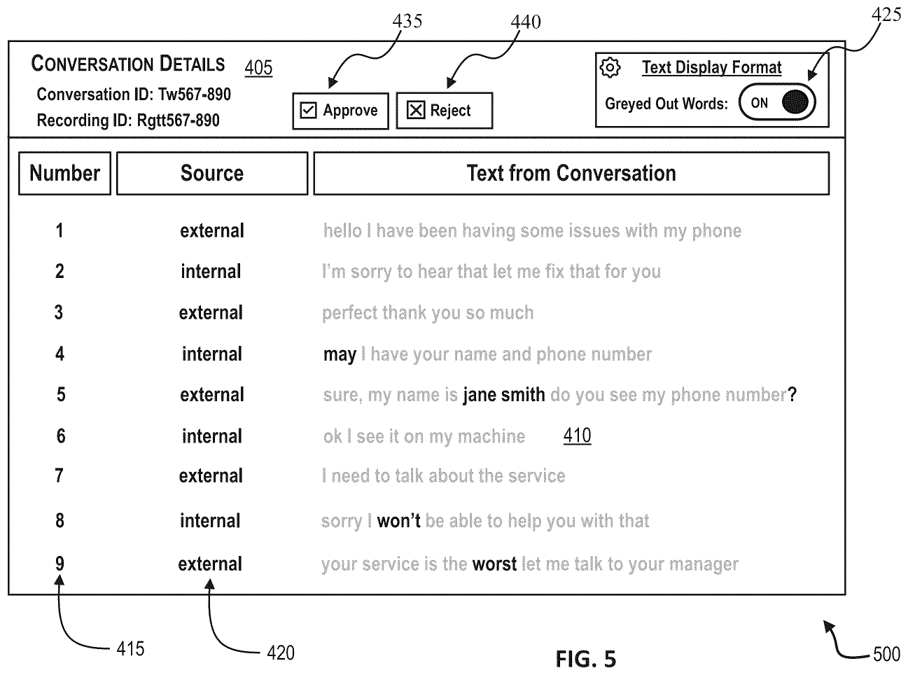

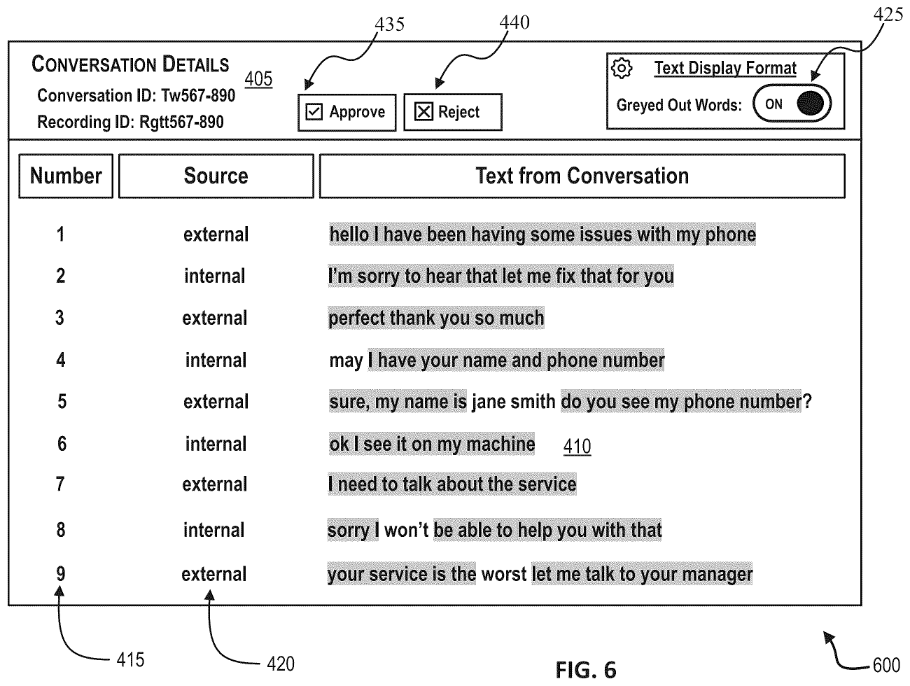

The method 300 may continue at step 320 by generating, for use by the user, a user interface that displays the subject text such that a visual format of the first text differs from a visual format of the second text in accordance with a visual format alteration. In exemplary embodiments, the visual format alteration is configured such that a visual prominence of the words of the second text is enhanced in relation to a visual prominence of the words of the first text. The present invention anticipates that this enhanced visual prominence may be accomplished in several different ways. For example, in certain embodiments, the visual format alteration includes rendering the first text and the second text in different colors. For example, the second text may be visually emphasized by rendering it in color that is darker than that used to render the first text. The darker color may be done either by varying tint, shade, or tone. In a preferred embodiment, this type of visual format alteration is done by greying out the first text while the second text is maintained as black or another dark color. An example of this type of embodiment is depicted in FIG. 5. In another embodiment, the visual format alteration is done by rendering the first text and second text over different colored backgrounds. For example, the first text may be visually deemphasized by making the background of the first text darker than the background of the second text. For example, the first text may be rendered over a grey background while the background of the second text is white. An example of this type of embodiment is depicted in FIG. 6. Other visual format alterations are also possible. For example, the first text and second text may be rendered in a different font style or font size. In another example, the visual format alteration includes bolding the second text while the first text is not in bold.

In certain embodiments, the method may include steps of generating the non-PII wordlist. In certain embodiments, this process begins by generating a domain specific wordlist that is derived from a domain specific text corpus. For example, the domain specific text corpus may be text derived from past conversations occurring between other customers and other agents of the contact center. In creating the domain specific text corpus, the prior conversations may be selected in relation to a common subject matter characteristic. From there, the method continues by calculating use frequency for the words appearing in the specific text corpus. As used herein, “use frequency” is a calculation as to how frequently each word is used in the specific text corpus. The domain specific wordlist is then generated by selecting for inclusion therein a predetermined number of the most frequently used words in the domain specific text corpus. The domain specific wordlist may then form the basis for a candidate non-PII wordlist. In other embodiments, the candidate non-PII wordlist is further based on a general wordlist. The general wordlist is derived by creating a general text corpus from text derived from a plurality of general sources, as already discussed. Use frequency may then be calculated for words appearing in the general text corpus. The general wordlist is then generated by selecting for inclusion therein a predetermined number of the most frequently used words in the general text corpus. With the derivation of the general wordlist now complete, the candidate non-PII wordlist may be based on both the domain specific wordlist and general wordlist. For example, the candidate non-PII wordlist may be a deduplicated combination of the domain specific wordlist and the general wordlist.

Whether the candidate non-PII wordlist is based on the domain specific wordlist, the general wordlist, or both, the next step involves a human review by a native speaker who is PII-trained. During this review, the native speaker identifies words that may constitute PII in a subject text. For example, these words may include those that are often used in a person's name, an address, or other type of PII. The identified words are then removed. This may be done, for example, by generating a user interface that displays the candidate non-PII wordlist to the reviewer. Input then is received from the reviewer in association with the generated user interface whereby one or more words on the candidate non-PII wordlist are selected for removal therefrom. The removal is based on a determined likelihood by the reviewer that the one or more words comprise PII words. Once the review is complete, the remaining words from the candidate non-PII wordlist (i.e., those not selected for removal by the reviewer) then become the finalized non-PII wordlist.

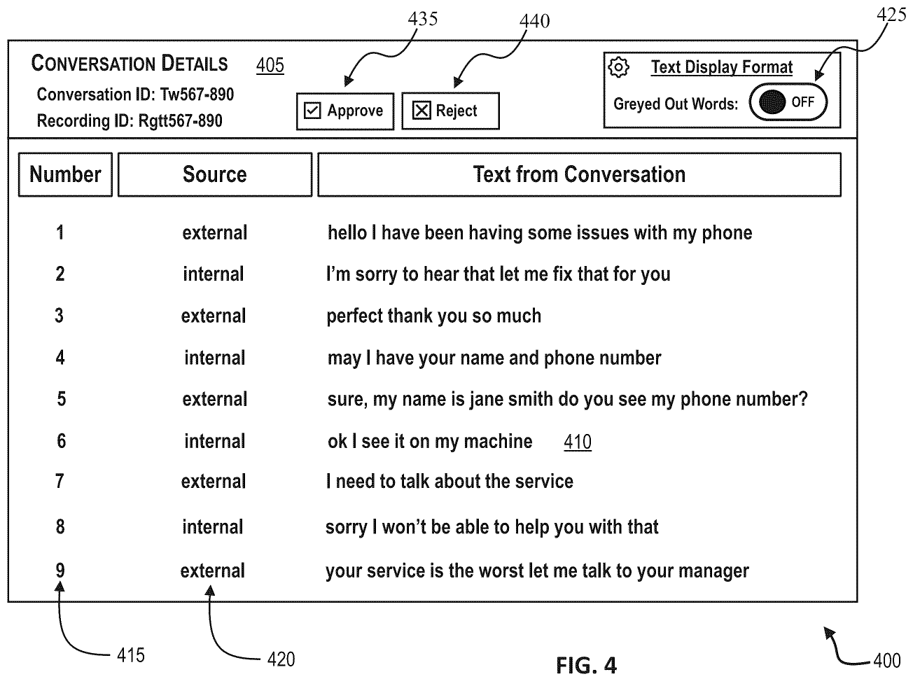

With reference now to FIGS. 4-6, exemplary user interfaces are shown in accordance with embodiments of the present invention. With specific reference to FIG. 4, a user interface 400 is shown. In this initial example, the text of the conversation is shown as unmodified by any of the possible visual format alterations introduced above. In FIGS. 5 and 6, exemplary visual format alterations are shown, providing examples as to how the subject text may be visually presented so the anonymization review is made more efficient.

As indicated in FIG. 4, the user interface 400 may include a header portion 405 and a body portion 410. The header portion 405 may include information about the subject text that is being reviewed. Further the header portion 405 may include several input features. Within the body portion 410, the subject text is displayed for review by the user. The body portion 310 may further include numbers 315 that indicate an order of the statements within the conversation of the subject text. The body portion 410 may also include a source identifier 420 that indicates which participant each statement of the subject text is attributed to. In regard to the source identifier 420, it will be appreciated that “internal” represents a statement from an agent, and “external” represents a statement from a customer.

Several input features may be provided in the header portion 405. For example, a toggle input 425 may be provided. In accordance with exemplary embodiments, the toggle input 425 allows a user to provide input that toggles between a user interface in which the subject text is unmodified (as shown in FIG. 4) and an interface in which the subject text is visually modified in accordance with a visual format alteration (examples of which are provided in FIGS. 5 and 6). Thus, in FIG. 4, words of the subject text that are found to match words in the non-PII wordlist are shown in the same visual format as words of the subject text that are found not to match words in the non-PII wordlist. As shown, the header portion 405 may further include an approve input 435 and a reject input 440. The approve input 435 enables the user to provide input indicating that the subject text stands approved based on the user verifying that the subject text does not include PII. The reject input 440 enables the user to provide input indicating that the subject text stands rejected based on the user finding that the subject text includes PII.

Turning now to FIG. 5, in which like numerals correspond to like parts, a user interface 500 is shown according to a preferred embodiment. In this case, the user has activated the toggle input 425 so that functionality of the text formatting tool modifies the manner in which the subject text is presented. Specifically, the user interface 500 is generated so that display “first text” (which, as used herein, refers to the words in the subject text found to match words in the non-PII wordlist) is displayed in a different visual format than “second text” (which, as used herein, refers to the words in the subject text found not to match any of the words in the non-PII wordlist). Thus, in user interface 500, the subject text is rendered so that the visual format of the first text differs from the visual format of the second text in accordance with a visual format alteration. According to the present invention, the visual format alteration is configured such that the subject text is displayed so that the words of the second text are visually emphasized (i.e., have an enhanced visual prominence) in comparison to the words of the first text. In the preferred embodiment of FIG. 5, the visual format alteration is one in which the first text is greyed out while the second text is maintained prominently in black. As shown, this makes the second text stand out visually in relation to the first text. As already described, this effect enables the reviewer to concentrate on the second text and more efficiently complete their review. Further, given the manner in which the non-PII wordlist is generated to include frequently used words, functionality of the present invention results in a substantial majority of the words being visually deemphasized, i.e., greyed out. As will be appreciated, this result significantly reduces the workload of the review. For example, the reviewer, concentrating on the emphasized text, is efficiently notified that the subject text still includes PII, as the name “Jane Smith” has not been greyed out.

Turning now to FIG. 6, in which like numerals correspond to like parts, a user interface 600 is shown according to a preferred embodiment. In this case too, the toggle input 425 has been activated by the user so that the functionality of text formatting tool modifies the manner in which the subject text is presented. Thus, as before, the subject text of the user interface 600 has been rendered so that the visual format of the first text differs from the visual format of the second text.

In this instance, the visual format alteration is one in which the words of the second text are visually emphasized via a change in background. Specifically, in this alternative embodiment, the first text and second text are rendered over different colored backgrounds. The first text is deemphasized by making the background of the first text darker than the background of the second text. As shown, the first text is rendered over a grey background while the background of the second text is rendered over a white background, which enhances the visual prominence of the second text relative to that of the first text. Again, the reviewer, concentrating on the emphasized text, is efficiently notified that the subject text still includes PII, as the name “Jane Smith” has not been deemphasized. Other visual format alterations may be included in other embodiments, as described above.

As already touched on, there are several advantages associated with the text formatting tool of the present invention. These advantages have been confirmed via experimentation. Specifically, experiments have been conducted that compare the review times for reviewers using the text formatting tool (which included greyed out/non-greyed out text) against reviewers that were not. The results of the experiments consistently show that the text formatting tool allows reviewers to achieve faster review rates (i.e., a measure as to how much text can be reviewed per unit of time). Specifically, the review rates are 3-5 times faster than review rates without the text formatting tool. The accuracy of the reviews have also improved or at least stayed the same. Further, reviewers report that they are able to maintain highly effective review for longer periods due to the reduced cognitive load that the present invention enables. And, the functionality that allows domain specific words to be greyed out has been found to significantly lighten the vocabulary load to reviewers. That is, with this functionality, the portion of the text that remains for manual review—i.e., the portion that is not greyed out—does not typically contain domain specific vocabulary, which can slow the review process because of unfamiliarity.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the present application as defined by the following claims and the equivalents thereof.

That which is claimed:

1. A method for facilitating anonymization certification of a subject text by a first user, wherein the anonymization certification comprises verifying by the first user that the subject text does not contain personal identifiable information (PII), the method comprising the steps of:
receiving the subject text;
receiving a non-PII wordlist in which are listed non-PII words;
comparing each word appearing in the subject text to the non-PII words found in the non-PII wordlist to determine matches therebetween so that, via the comparison, the words of the subject text are classified as being either first text, which includes the words in the subject text found to match one of the non-PII words, and second text, which includes the words in the subject text found not to match any of the non-PII words; and
generating, for use by the first user, a first user interface that displays the subject text such that a visual format of the first text differs from a visual format of the second text in accordance with a visual format alteration.

2. The method of claim 1, wherein the subject text comprises text derived from a conversation between an agent in a contact center and a customer; and
wherein PII is defined as information that permits an identity of an individual to whom the information applies to be reasonably inferred.

3. The method of claim 2, wherein the conversation comprises a spoken exchange;
further comprising the steps of recording the conversation and transcribing the recorded conversation via automatic speech recognition to create the subject text.

4. The method of claim 2, wherein the visual format alteration is configured to enhance a visual prominence of the words of the second text in relation to a visual prominence of the words of the first text.

5. The method of claim 2, wherein the visual format alteration comprises rendering the first text and the second text in different colors.

6. The method of claim 5, wherein the color of the second text is darker than the color of the first text.

7. The method of claim 5, wherein the visual format alteration comprises greying out the first text while maintaining the second text as black.

8. The method of claim 2, wherein the visual format alteration comprises rendering the first text and the second text over different backgrounds.

9. The method of claim 8, wherein the background of the first text is darker than the background of the second text.

10. The method of claim 8, wherein the background of the first text is grey and the background of the second text is white.

11. The method of claim 2, wherein the visual format alteration comprises rendering the first text and the second text in at least one of:
a different font style; or
a different font size.

12. The method of claim 2, wherein the visual format alteration comprises rendering the second text as bold text while maintaining the first text as text that is not bold.

13. The method of claim 2, wherein the first user interface further comprises:
a toggle input that enables the first user to provide input that toggles between the first user interface and a second user interface, wherein the second user interface displays the subject text such that the words of the first text and the words of the second text are both shown in a same visual format, wherein the same visual format comprises the visual format of the second text in the first user interface.

14. The method of claim 2, wherein the first user interface further comprises:
a reject input that enables the first user to provide input indicating that the subject text stands rejected based on the first user finding that the subject text includes PII; and
an approve input that enables the first user to provide input indicating that the subject text stands accepted based on the first user verifying that the subject text does not include PII.

15. The method of claim 2, further comprising the steps of generating the non-PII wordlist by:
creating a domain specific text corpus from text derived from past conversations occurring between other customers and other agents of the contact center;
calculating use frequency for words appearing in the domain specific text corpus;
generating a domain specific wordlist by selecting for inclusion therein a predetermined number of the most frequently used words in the domain specific text corpus;
creating a candidate non-PII wordlist based on at least the domain specific wordlist;
generating a third user interface that displays the candidate non-PII wordlist to a second user for review by the second user; and
receiving input supplied by the second user in association with the third user interface whereby one or more words on the candidate non-PII wordlist are selected for removal therefrom based on a determined likelihood by the second user that the one or more words comprise PII words;
wherein the non-PII wordlist comprises the remaining words on the candidate non-PII wordlist.

16. The method of claim 15, wherein, in creating the domain specific text corpus, the prior conversations are selected in relation to a common subject matter characteristic.

17. The method of claim 15, wherein the steps of generating the non-PII wordlist further include:
creating a general text corpus from text derived from a plurality of general sources;
calculating use frequency for words appearing in the general text corpus;
creating a general wordlist by selecting for inclusion therein a predetermined number of the most frequently used words in the general text corpus;
creating the candidate non-PII wordlist based on both the domain specific wordlist and the general wordlist.

18. The method of claim 17, wherein the candidate non-PII wordlist comprises a deduplicated combination of the domain specific wordlist and the general wordlist.

19. A system for facilitating anonymization certification of a subject text by a first user, wherein the anonymization certification comprises verifying by the first user that the subject text does not contain personal identifiable information (PII), the system comprising:
a processor; and
a memory storing instructions which, when executed by the processor, cause the processor to perform the steps of:
receiving the subject text;
receiving a non-PII wordlist in which are listed non-PII words;
comparing each word appearing in the subject text to the non-PII words found in the non-PII wordlist to determine matches therebetween so that, via the comparison, the words of the subject text are classified as being either first text, which includes the words in the subject text found to match one of the non-PII words, and second text, which includes the words in the subject text found not to match any of the non-PII words; and
generating, for use by the first user, a first user interface that displays the subject text such that a visual format of the first text differs from a visual format of the second text in accordance with a visual format alteration;
wherein the visual format alteration is configured to enhance a visual prominence of the words of the second text in relation to a visual prominence of the words of the first text.

20. The system of claim 19, wherein the visual format alteration comprises greying out the first text while maintaining the second text as black;
wherein the memory stores further instructions that, when executed by the processor, cause the processor to generate the non-PII wordlist by perform the steps of:
creating a domain specific text corpus from text derived from past conversations occurring between other customers and other agents of the contact center;
calculating use frequency for words appearing in the domain specific text corpus;
generating a domain specific wordlist by selecting for inclusion therein a predetermined number of the most frequently used words in the domain specific text corpus;
creating a candidate non-PII wordlist based on at least the domain specific wordlist;
generating a third user interface that displays the candidate non-PII wordlist to a second user for review by the second user; and
receiving input supplied by the second user in association with the third user interface whereby one or more words on the candidate non-PII wordlist are selected for removal therefrom based on a determined likelihood by the second user that the one or more words comprise PII words;
wherein the non-PII wordlist comprises the remaining words on the candidate non-PII wordlist.
